(19) United States
(12) Patent Application Publication
(10) Pub. No.: US 2004/0190200 A1
(43) Pub. Date: Sep. 30, 2004

(54) Magnetic disk cartridge

(75) Inventor: Harumi Aoishi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/806,425

(22) Filed: Mar. 23, 2004

(30) Foreign Application Priority Data
Mar. 25, 2003 (JP) 082889/2003

(51) Int. Cl. G11B 23/03

(52) U.S. Cl. 360/133

(57) ABSTRACT

A magnetic disk cartridge having a shutter formed in a stepped configuration, which is capable of preventing damage to a data area of the magnetic disk by the step formed in the shutter, for example, when the magnetic disk cartridge is inserted into a drive. The magnetic disk cartridge has a housing constituted by a resin frame and upper and lower shell halves formed of metal sheets. The housing rotatably accommodates a magnetic disk and a rotary shutter therein. The rotary shutter is constituted by upper and lower shutter halves, each of which is formed in a stepped configuration. Junctures between surface regions located closer to the magnetic disk and transition regions of the upper and lower shutter halves are positioned at radial positions corresponding to areas other than the data area of the magnetic disk 5.

### BACKGROUND OF THE INVENTION

1. Field of the Invention

The present invention relates to compact magnetic disk cartridges, which are replaceably held within a card type disk drive that can be inserted into a card slot of an electronic apparatus such as a digital still camera, a digital video camera, a laptop personal computer or the like.

2. Description of the Related Art

Conventionally, mobile equipment such as digital cameras and the like use as recording media very small magnetic disk cartridges called “clik!™” as disclosed in U.S. Pat. No. 6,256,168.

This magnetic disk cartridge comprises a flat housing (width 50 mm, depth 55 mm, thickness 95 mm) constituted by a resin frame including a push portion, and upper and lower shell halves formed of thin metal sheets; and a 1.8 inch diameter magnetic disk with a 40 MB storage capacity and rotatably accommodated within the flat housing.

The housing of the magnetic disk cartridge has a wedge-shaped opening to allow a magnetic head of a drive device to access a surface of the magnetic disk. A rotary shutter which is formed of a thin metal sheet is used to open and close this opening. This rotary shutter is spring-loaded towards its closing direction by means of a small-diameter elongate coil spring.

In the left end surface of the housing, a notch to be engaged with a latching portion formed within the drive device is provided to ensure positioning of the cartridge in the drive device. Meanwhile, in the right end surface of the housing, a small window for exposing a shutter lock member towards the outside is provided to keep the rotary shutter locked in the closed position.

The lower shell half of the housing includes a circular opening through which a rotary spindle of the drive device couples with the center core of the magnetic disk, and an arcuate groove concentric with the rotary shutter. The rotary shutter has a shutter knob which is fixedly provided thereon and protrudes from the aforementioned arcuate groove. The shutter knob travels along this arcuate groove to allow opening and closing of the rotary shutter.

In order to reduce the area of sliding contact with the housing and to increase the strength of the shutter, each of the surfaces of the rotary shutter of the aforementioned “clik!™” facing the upper and lower surfaces of the magnetic disk is formed in a stepped configuration so as to provide a surface region located closer to the housing, a surface region located closer to the magnetic disk, and a transition region extending between the these surface regions.

Providing such a step as mentioned above, however, could cause abutment of the juncture or edge between the surface region located closer to the magnetic disk and the transition region of the inner surface (the surface closer to the magnetic disk) of the rotary shutter against the data area of the magnetic disk when the magnetic disk cartridge 1 is inserted into the drive device body 20, when the magnetic disk cartridge 1 is dropped, and the like, and accordingly the data area could be damaged.

### SUMMARY OF THE INVENTION

In view of the foregoing problem, it is an object of the present invention to provide a magnetic disk cartridge having a shutter formed in a stepped configuration, wherein the data area is prevented from being damaged by the step provided in the shutter, for example, when the magnetic disk cartridge is inserted into a drive.

A magnetic disk cartridge according to the present invention comprises: a flexible magnetic disk which has a center core fixedly attached thereto; and a housing which accommodates therein the magnetic disk. The housing has an opening and a shutter placed inside the housing. The shutter rotates around substantially the same point as the center of the magnetic disk, thereby opening and closing the opening. One surface of the shutter on the side facing the data area is constituted by a surface region located closer to the housing, a surface region located closer to the magnetic disk, and a transition region extending between these surface regions. The juncture between the surface region located closer to the magnetic disk and the transition region is disposed outside the data area when viewed from the direction substantially perpendicular to the data area surface of the magnetic disk.

It will be noted that the expressions “surface region closer to the housing” and “surface region closer to the magnetic disk” as used here refer to the relative positional relationship when the surface of the. shutter facing the magnetic disk is viewed from the side of the magnetic disk.

The invention can be applied to the magnetic disk cartridge called “clik!™” by assigning an area within a 9 mm radius of the center of the magnetic disk as the area outside the data area. In this case, proper assembly can be achieved by disposing the juncture between the surface region located closer to the magnetic disk and the transition region within an area of 8.5 mm radius of the rotational center of the magnetic disk

The magnetic disk cartridge according to the invention comprises a shutter which has, on a surface facing a data area of the magnetic disk, a surface region located closer to the housing; a surface region located closer to the magnetic disk; and a transition region extending between the surface regions, wherein the juncture between the surface region located closer to the magnetic disk and the transition region is disposed outside the data area when viewed from the direction substantially perpendicular to the data area surface of the magnetic disk. This prevents abutment of the juncture against the data area of the magnetic disk even if the juncture is brought into contact with the magnetic disk when the magnetic disk cartridge is inserted into the drive device body, when the magnetic disk cartridge is dropped, or for any other reason.

### BRIEF DESCRIPTION OF THE DRAWINGS

FIG. 1A, FIG. 1B, and FIG. 1C respectively illustrate a plan view, a right side view, and a bottom view of a magnetic disk cartridge according to one embodiment of the invention;

FIG. 2 is a cross sectional view the magnetic disk cartridge of FIG. 1A taken along line II-II in FIG. 1A; and

FIG. 3 is a plan view showing a body of a PC card type drive device suitable for use with the magnetic disk cartridge illustrated in FIG. 1.

### DESCRIPTION OF THE PREFERRED EMBODIMENTS

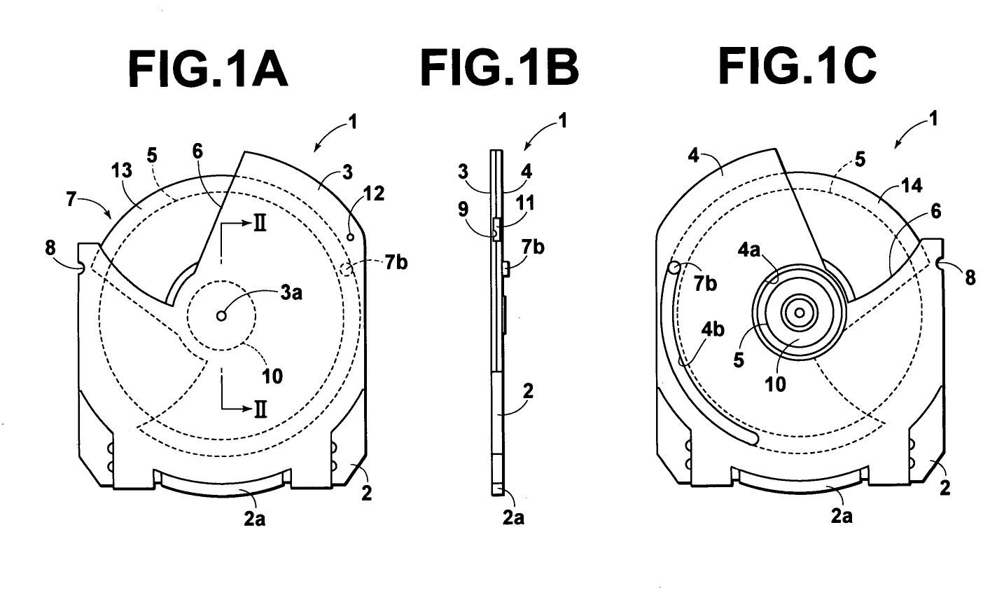

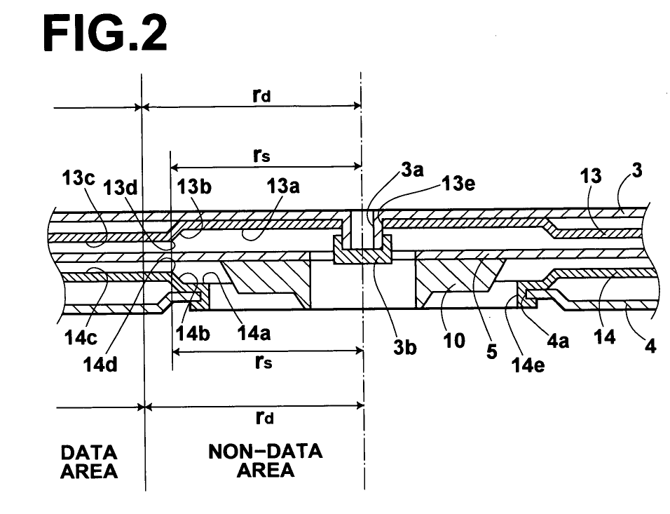

Hereinafter, a preferred embodiment of the present invention will be described in detail with reference to the drawings. FIGS. 1A to 1C illustrate a very small magnetic disk cartridge called “clik!™” which is removably received within a PC card type drive device in a push-and-pull manner. FIG. 1A is a plan view, FIG. 1B is a right side view, and FIG. 1C is a bottom view. FIG. 2 is a cross sectional view taken along line II-II in FIG. 1A. For ease of understanding, respective components illustrated in FIG. 2 are not necessarily drawn to scale.

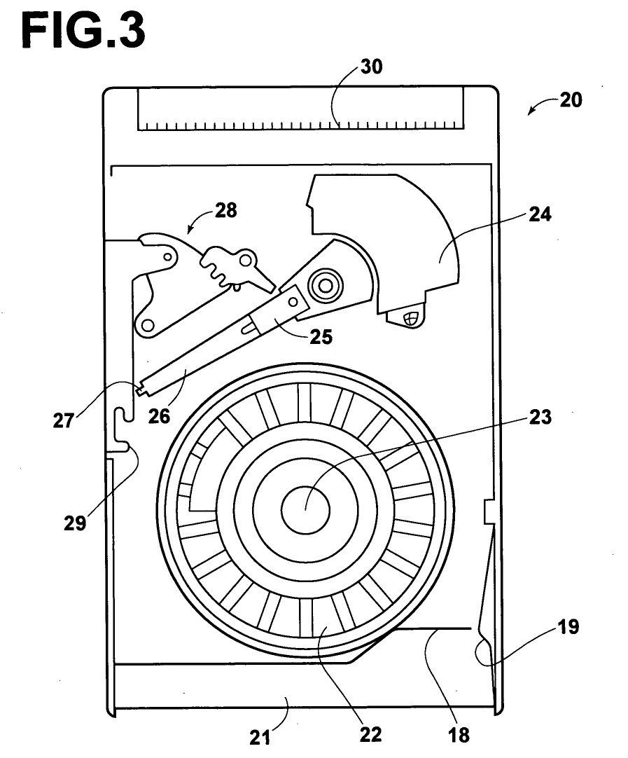

FIG. 3 is a plan view showing a body of the PC card type drive device according to the invention. This drive device comprises a drive device body 20 (shown), and a metal upper lid (not shown) which is put on the body 20 and has substantially the same overhead contour as that of the body 20.

A magnetic disk cartridge 1 shown in FIG. 1 comprises a 1.8″ (45.7 mm) diameter magnetic disk 5 with a 40 MB storage capacity; and a flat housing (width 50 mm, depth 55 mm, thickness 1.95 mm) which rotatably accommodates the magnetic disk 5 therein. The housing is constituted by a resin frame 2 including a push portion 2a, and upper and lower cartridge-shell halves 3 and 4 formed of thin metal sheets.

The aforementioned housing is provided with a wedge-shaped opening 6 to allow a magnetic head 27 of the drive device body 20 shown in FIG. 3 to access a surface of the magnetic disk 5, and a generally arcuate rotary shutter 7 used to open and close this opening 6. The rotary shutter 7 is constituted by an upper shutter half 13 and a lower shutter half 14, which are configured to be engaged with one another so that they can move as a unit. The rotary shutter 7 is spring-loaded towards its closing direction (in the counter-clockwise direction in FIG. 1A) by means of a small-diameter elongate coil spring (not shown) provided within the housing.

A cylindrical projection 3a formed on the upper shell half 3 by burring is passed through a receiving portion 13e formed in the upper shutter half 13, and then a removal prevention member 3b is attached to the distal end of the cylindrical projection 3a, whereby the upper shutter half 13 is held rotatably around the projection 3a by the upper shell half 3.

Meanwhile, a cylindrical projection 14e formed on the lower shell half 14 by burring is passed through a receiving portion 4a formed in the lower shutter half 4 and then the distal end of the projection 14e is subjected to swaging, whereby the lower shutter half 14 is held rotatably around the receiving portion 4a by the lower shell half 4.

Each of the upper and lower shutter halves 13, 14 comprises a surface region located closer to the corresponding shell half 3, 4, a surface region located closer to the magnetic disk 5, and an transition region which extends therebetween, and these surface regions are arranged in a stepped configuration with the junctures between respective two adjacent surface regions being disposed substantially concentrically. In this embodiment, the stepped configuration is provided such that the surface regions-located closer to the upper and lower shell half 3, 4 are disposed on the radially inner side of the rotary shutter 7.

In the magnetic disk 5, an area inside a boundary radius r_{d} is a non-data area and another area outside the boundary radius r_{d} is a data area. Thus, the surface regions 13c, 14c of the upper and lower shutter halves 13, 14 which are located closer the magnetic disk 5, and the junctures 13d, 14d between the surface regions 13c, 14c and the transition region 13b, 14b are arranged so that each radius rₛ from the center to the juncture 13d, 14d is disposed radially inward from the boundary radius rd when viewed from the center of the magnetic disk 5.

More specifically, since the aforementioned boundary radius rd of “clik!™” is 9 mm, the radius rₛ from the center to the juncture 13d, 14d is set 8.5 mm.

Consequently, even if the juncture 13d, 14d is brought in contact with the data area of the magnetic disk 5 in some cases such as when the magnetic disk cartridge 1 is inserted into the drive device body 20 or when the magnetic disk cartridge 1 is dropped, or for any other reason, direct contact with the data area is prevented, and thus the data area is protected from damage.

In the left end surface of the housing, a notch 8 to be engaged with a latching member 29 formed within the drive device body 20 is provided to ensure positioning of the cartridge in the drive device body 20. On the other hand, in the right end surface of the housing, a small window 9 for exposing a shutter lock member 11 towards the exterior is provided to keep the rotary shutter 7 locked in the closed position. FIGS. 1A to 1C show the state that the rotary shutter 7 is locked in the closed position.

The lower shell half 4 of the housing includes a circular opening 4a through which a rotary spindle 23 of the drive device 20 couples with a center core 10 of the magnetic disk 5, and an arcuate groove 4b concentric with the rotary shutter 7. The rotary shutter 7 has a shutter knob 7b provided immovably thereon which projects from the aforementioned arcuate groove 4b and travels along this arcuate groove 4b, thereby opening and closing the rotary shutter 7.

The shutter lock member 11 for locking the rotary shutter 7 in the closed position is rotatably mounted to the shaft 12 provided in the housing and is spring-loaded in the direction for locking the rotary shutter 7. When the magnetic disk cartridge 1 is inserted into the drive device body 20, an unlocking member 19 provided on the drive device body 20 pushes the shutter lock member 11 through the small window 9. This will cause the lock member 11 to be slightly rotated in the unlocking direction and thus the rotary shutter 7 is unlocked.

The drive device body 20 in FIG. 3 is a TYPE II PC card type drive device which is 53 mm wide, 85 mm deep, and 5 mm thick, and shown with a metal upper lid being removed. The drive device body 20 comprises a slot 21 into which the disk cartridge 1 is inserted, a spindle motor 22 having a spindle 23 which serves to magnetically attract the center core 10 of the magnetic disk 5, a head actuator 24, a swing arm 25, and a head suspension 26 supported by the swing arm 25. A magnetic head 27 which accesses the surface of the magnetic disk 5 during rotation thereof for recording and/or replaying information is disposed at a distal end of the head suspension 26.

The drive device body 20 further comprises a push-push type cartridge engagement and ejection mechanism 28 including a latching member 29 adapted to engage with a notch 8 of the magnetic disk cartridge 1, and an input/output interface 30 for interfacing to electronic equipment such as a digital camera, personal computer and the like to which the drive device body 20 is mounted.

On the back and right side of the slot 21 of the drive device body 20, an engaging wall 18, which extends laterally in a direction substantially perpendicular to the insertion direction of the magnetic disk cartridge 1, is formed as a shutter opening means, and further an unlocking member 19 is provided which releases the rotary shutter 7 from its closed and locked position upon insertion of the magnetic disk cartridge 1.

When the magnetic disk cartridge 1 is inserted into the slot 21 of the drive device, the unlocking member 19 first pushes the shutter lock member 11 and then the shutter knob 7b engages with the engaging wall 18 under this state. Therefore, as the magnetic disk cartridge 1 is inserted, the shutter knob 7b is slid along the engaging wall 18, during which the rotary shutter 7 moves to its open position while compressing its urging coil spring. At the same time, the latching member 29 of the drive device body 20 engages with the notch 8 of the magnetic disk cartridge 1, and thus the magnetic disk cartridge 1 is held in position within the drive device body 20.

To remove the magnetic disk cartridge 1 from the drive device, on the other hand, it is necessary to press the push portion 2a of the magnetic disk cartridges 1 such that the cartridge engagement and ejection mechanism 28 pushes out the magnetic disk cartridge 1. At this time, the initial velocity for ejection is ensured by the compressed coil spring for urging the rotary shutter. The rotary shutter 7 is rotated to its closed position by the urging force of the aforementioned coil spring as the magnetic disk cartridge 1 is pulled out, and finally locked by the shutter lock member 11.

The present invention has been described in connection with the specific embodiment where a stepped rotary shutter is provided in the manner such that the surface region located closer to the housing is disposed on the radially inner side of the rotary shutter, and that the juncture of the rotary shutter is disposed radially inward from the data area of the magnetic disk. However, the present invention is not limited thereto, and the surface region located closer to the housing may be disposed on the radially outer side of the rotary shutter, and the juncture of the rotary shutter may be disposed radially outward from the data area of the magnetic disk.

What is claimed is:

1. A magnetic disk cartridge comprising:
a flexible disk which has a center core fixedly attached thereto;
a housing which has an opening and accommodates therein the magnetic disk, the housing further incorporating therein a shutter which rotates around the substantially same point as that of the center of the magnetic disk, thereby opening and closing the opening; and
one surface of the shutter on the side facing a data area of the magnetic disk being constituted by:
a surface region located closer to the housing;
a surface region located closer to the magnetic disk; and
a transition region extending therebetween,
wherein the juncture between the surface region located closer to the magnetic disk and the transition region is disposed at a radial position corresponding to an area other than the data area of the magnetic disk.

2. A magnetic disk cartridge according to claim 1, wherein an area within a 9 mm radius of the center of the magnetic disk is the area other than the data area.

3. A magnetic disk cartridge according to claim 1, wherein the juncture between the surface region located closer to the magnetic disk and the transition region is positioned within an area of 8.5 mm radius of the rotational center of the magnetic disk.

4. A magnetic disk cartridge according to claim 2, wherein the juncture between the surface region located closer to the magnetic disk and the transition region is provided within an area of 8.5 mm radius of the rotational center of the magnetic disk.
